(19) United States
(12) Patent Application Publication
(10) Pub. No.: US 2006/0076343 A1
(43) Pub. Date: Apr. 13, 2006

(54) Film heating element having automatic temperature control function

(76) Inventor: Cheng-Ping Lin, Taipei City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/963,453

(22) Filed: Oct. 13, 2004

(51) Int. Cl. H05B 3/16

(52) U.S. Cl. 219/543

(57) ABSTRACT

A film heating element includes a substrate, an electrothermal film layer coated on a surface of the substrate and made of a material having a PTC effect, and two electrodes mounted on two opposite sides of the electrothermal film layer and each electrically connected to the electrothermal film layer. Thus, the film heating element has a simplified construction and does not need a temperature control.

### BACKGROUND OF THE INVENTION

1. Field of the Invention

The present invention relates to a film heating element, and more particularly to a film heating element having an automatic temperature control function.

2. Description of the Related Art

A conventional heating device includes a heating element consisting of a nickel-chromium coil or a quartz tube disposed at a proper position. The heating element is heated in a heat convection manner with the air as a medium of heat transfer. However, the heat transfer efficiency in the air is poor, so that the heating temperature of the heating element is not evenly distributed. In addition, the conventional heating device has a larger volume, and the heating temperature of the heating element cannot be controlled easily.

Another conventional heating device is disclosed in the Taiwanese Patent Publication No. 472997 and comprises an electrothermal film. The electrothermal film includes a substrate, a silver gel, and an electrode. The substrate has a first side provided with a far infrared layer and a second side provided with an electrothermal film layer. The electrothermal film layer has a conductive protective layer having an oxidation surface. The silver gel is located at a predetermined position of the protective layer and is electrically connected to an inside of the protective layer. The electrode is electrically connected to the electrothermal film layer through the protective layer and the silver gel. Thus, the electrothermal film layer co-operates with the far infrared layer to produce far infrared rays so as to heat a target efficiently. In such a manner, the conventional heating device uses the electrothermal film to function as a heating source.

However, the substrate is provided with the far infrared layer in a high temperature sintering manner, thereby complicating the working process. In addition, the substrate is located between the far infrared layer and the electrothermal film layer, thereby decreasing the heat transfer efficiency. Further, the electrothermal film is made of electric resistance material, so that the temperature cannot be controlled easily. Thus, it is necessary to provide a temperature control device additionally.

Another conventional heating device comprises a PTC heating body formed by a pressing or extruding process. The PTC heating body is made of PTC material. When an electric field is applied on the PTC heating body, the PTC heating body produces a larger electric current and a larger current density, so that the PTC heating body produces a larger heat to increase the temperature, and the temperature increasing rate reaches 10⁴ to 10⁶K/S. The crystal of the PTC heating body is a semiconductor and the crystal boundary of the PTC heating body is a highly resistant body, so that the external electric field is mainly applied on the crystal boundary of the PTC heating body. The electric intensity on the crystal boundary of the PTC heating body may reach one hundred times of that applied on the testing sample, thereby producing a high temperature. However, when the resistance in the ceramic blank of the PTC material of the PTC heating body is not distributed evenly, the temperature is not distributed evenly. In addition, when the temperature is increased to a determined value (the Curie temperature point), the pressure stress is converted into a tension stress suddenly due to a phase variation, so that the stress reaches the limit value. However, the ceramic blank of the PTC material of the PTC heating body has a poor capacity to resist the tension stress, so that the ceramic blank of the PTC material of the PTC heating body is easily broken. Further, when the component or crystal of the PTC material of the PTC heating body is not distributed evenly, the ceramic blank of the PTC material of the PTC heating body easily produces hot spots, thereby causing a heat break or an electric perforation.

### SUMMARY OF THE INVENTION

In accordance with the present invention, there is provided a film heating element, comprising:

a substrate;

an electrothermal film layer coated on a surface of the substrate and made of a material having a PTC effect; and

two electrodes mounted on two opposite sides of the electrothermal film layer and each electrically connected to the electrothermal film layer.

The primary objective of the present invention is to provide a film heating element having an automatic temperature control function.

Another objective of the present invention is to provide a film heating element, wherein the electrothermal film layer is made of the PTC effect material having a positive temperature coefficient, so that the film heating element has a simplified construction and does not need a temperature control.

A further objective of the present invention is to provide a film heating element, wherein the substrate is integrally formed with the functional far infrared material without needing a high temperature sintering process, thereby simplifying the manufacturing process.

A further objective of the present invention is to provide a film heating element, wherein the thermal insulating layer is coated on the top face of the electrothermal film layer to provide a thermal insulating effect to the electrothermal film layer.

Further benefits and advantages of the present invention will become apparent after a careful reading of the detailed description with appropriate reference to the accompanying drawings.

### BRIEF DESCRIPTION OF THE DRAWINGS

FIG. 1 is a plan view of a film heating element in accordance with the preferred embodiment of the present invention; and

FIG. 2 is a plan cross-sectional view of the film heating element in accordance with the preferred embodiment of the present invention.

### DETAILED DESCRIPTION OF THE INVENTION

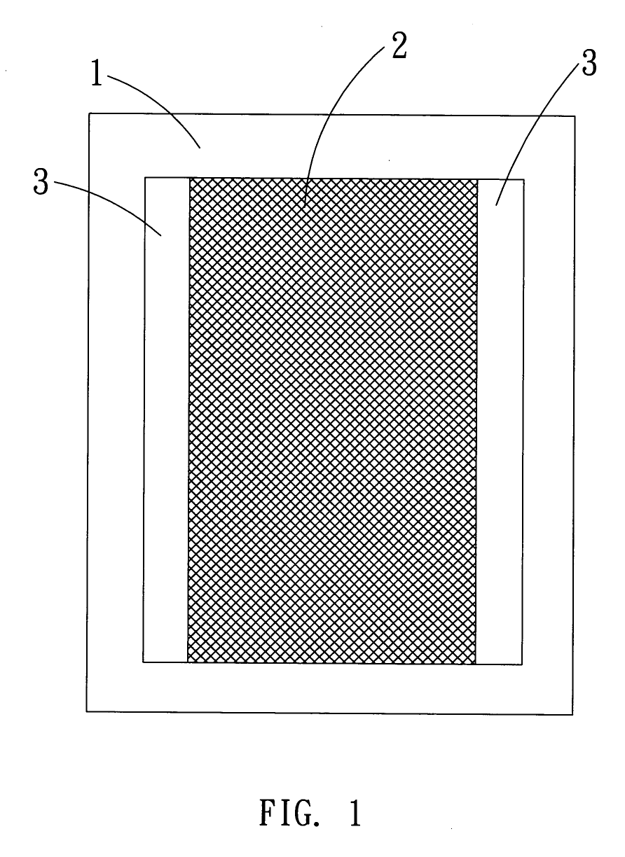

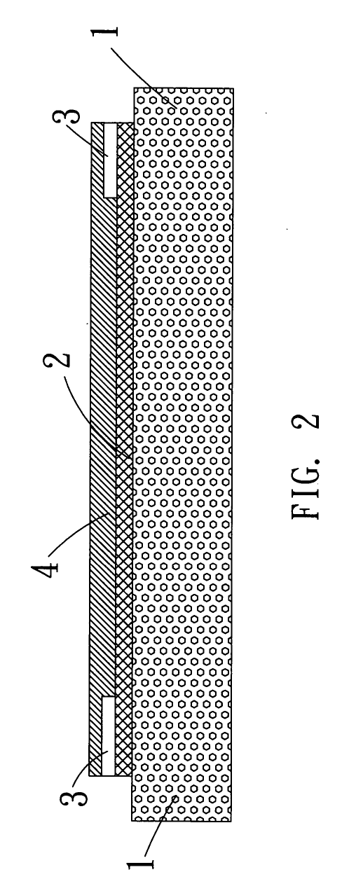

Referring to FIGS. 1 and 2, a film heating element in accordance with the preferred embodiment of the present invention comprises a substrate 1, an electrothermal film layer 2 coated on a surface of the substrate 1 and made of a material having a PTC effect, two electrodes 31 mounted on two opposite sides of the electrothermal film layer 2 and each electrically connected to the electrothermal film layer 2, and a thermal insulating layer 4 coated on a top face of the electrothermal film layer 2 to provide a thermal insulating effect to the electrothermal film layer 2. Thus, the electrothermal film layer 2 produces heat by electrical conduction of the two electrodes 31.

Preferably, the substrate 1 has a plate shape, a tubular shape or a cellular shape so that the substrate 1 is available for heating devices of different types.

In general, the PTC effect is described as follows. When the temperature is smaller, the resistance of the PTC material is smaller, and when the temperature is increased, the resistance of the PTC material is increased with rise of the temperature. When the temperature of the PTC material reaches a determined value, such as the Curie temperature point, the resistance of the PTC material is increased to reach that of an insulating body, so that the PTC material contains a voltage without passage of a current. In addition, the resistance of the PTC material is reduced due to dissipation of the temperature (the Curie temperature point is reduced), thereby producing a current to provide a power required for dissipation of the temperature so as to achieve a balance effect, which indicates the PTC effect.

Preferably, the PTC effect material of the electrothermal film layer 2 is a material having a positive temperature coefficient and having a PTC effect. When the temperature is increased, the impedance of the PTC material having a positive temperature coefficient is increased, so that the temperature will not be increased without restriction.

The electrothermal film layer 2 has a thickness smaller than 2 μm. In addition, the electrothermal film layer 2 is combined with the substrate 1 in a molecular link manner and in a high temperature diffusion chemical reaction manner, so that when the electrothermal film layer 2 severely produces heat instantaneously, the electrothermal film layer 2 will not produce a temperature differential and hot spots so as to overcome the shortcomings of the conventional PTC heating body formed by a pressing or extruding process. In addition, the electrothermal film layer 2 is made of the PTC effect material having a positive temperature coefficient, so that the film heating element has a simplified construction and does not need a temperature control.

In addition, the substrate 1 is added with a functional far infrared material, such as a ceramic material, to project far infrared rays onto an object to be heated. Preferably, the functional far infrared material is mixed with the substrate 1 before the substrate 1 is formed, so that the substrate 1 is integrally formed with the functional far infrared material without needing a high temperature sintering process, thereby simplifying the manufacturing process.

Accordingly, the electrothermal film layer 2 is made of the PTC effect material having a positive temperature coefficient, so that the film heating element has a simplified construction and does not need a temperature control. In addition, the substrate 1 is integrally formed with the functional far infrared material without needing a high temperature sintering process, thereby simplifying the manufacturing process. Further, the thermal insulating layer 4 is coated on the top face of the electrothermal film layer 2 to provide a thermal insulating effect to the electrothermal film layer 2.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A film heating element, comprising:
a substrate;
an electrothermal film layer coated on a surface of the substrate and made of a material having a PTC effect; and
two electrodes mounted on two opposite sides of the electrothermal film layer and each electrically connected to the electrothermal film layer.

2. The film heating element in accordance with claim 1, wherein the substrate has a plate shape.

3. The film heating element in accordance with claim 1, wherein the substrate has tubular shape.

4. The film heating element in accordance with claim 1, wherein the substrate has a cellular shape.

5. The film heating element in accordance with claim 1, wherein the electrothermal film layer has a thickness smaller than 2 μm.

6. The film heating element in accordance with claim 1, wherein the substrate is added with a functional far infrared material.

7. The film heating element in accordance with claim 6, wherein the substrate is integrally formed with the functional far infrared material.

8. The film heating element in accordance with claim 1, further comprising a thermal insulating layer coated on a top face of the electrothermal film layer to provide a thermal insulating effect to the electrothermal film layer.

9. The film heating element in accordance with claim 1, wherein the electrothermal film layer is made of a PTC effect material having a positive temperature coefficient

10. The film heating element in accordance with claim 1, wherein the PTC effect material of the electrothermal film layer is a material having a positive temperature coefficient and having a PTC effect.
